(19) United States
(12) Patent Application Publication
(10) Pub. No.: US 2023/0304235 A1
(43) Pub. Date: Sep. 28, 2023

(54) SELF-PROPELLED SUBSTRATE MILLING MACHINE AND METHOD FOR CONTROLLING A SELF-PROPELLED SUBSTRATE MILLING MACHINE

(71) Applicant: Wirtgen GmbH, Windhagen (DE)

(72) Inventors: Christian Berning, Züplich (DE); Mariusz Gasiorek, Altenkirchen (DE); Hanjo Held, Windhagen (DE); René Müller, Vettelschob (DE)

(21) Appl. No.: 18/187,166

(22) Filed: Mar. 21, 2023

(30) Foreign Application Priority Data
Mar. 23, 2022 (DE) 10 2022 106 808.0

(51) Int. Cl. E01C 23/088; E01C 23/12

(52) U.S. Cl. CPC E01C 23/088; E01C 23/127

(57) ABSTRACT

A self-propelled substrate milling machine includes a machine frame supported by front and rear left-hand and right-hand running gear units, wherein a milling drum is arranged on the machine frame. The substrate milling machine is characterized by a transverse inclination sensor system, which is designed to control the substrate milling machine in such a way that the position of the front left-hand and right-hand running gear units which stand on the unmachined substrate, is detected with respect to the machine frame, and transverse inclination values describing the transverse inclination of the substrate surface transverse to the working direction of the substrate milling machine with respect to the machine frame is determined from the position of these running gear units, said transverse inclination values being the basis for the control of the substrate milling machine. The transverse inclination sensor system detects the transverse inclination of the course of the route.

### RELATED APPLICATIONS

This application claims priority to German Patent Application Ser. No. DE 10 2022 106 808.0 filed Mar. 23, 2022, which is incorporated herein by reference.

### BACKGROUND ΔF THE DISCLOSURE

### Field of the Disclosure

The invention relates to a self-propelled substrate milling machine which comprises a machine frame which is supported by an undercarriage which has a front left-hand running gear unit and a front right-hand running gear unit and a rear left-hand and a rear right-hand running gear unit, wherein a milling drum is arranged on the machine frame. Furthermore, the invention relates to a method for controlling such a substrate milling machine.

### Description of the Prior Art

In the following, a substrate milling machine is understood to mean a milling machine which is suitable for milling material from a substrate. The substrate to be machined can, for example, be an existing traffic area (road) from which material is to be milled.

In road construction, self-propelled road milling machines of different designs are used. These construction machines include known road milling machines with which existing road layers of the top structure of the road can be removed. Known road milling machines have a rotating milling drum which is equipped with milling tools for machining the roadway. The milling drum is arranged on the machine frame, which is adjustable in height relative to the road to be machined. The height adjustment of the machine frame is effected by means of lifting columns which are assigned to the individual crawler tracks or wheels (running gear units). To mill a damaged road surface, the machine frame is lowered so that the milling drum penetrates the road surface. The lifting columns allow not only the height adjustment of the machine frame or milling drum but also the setting of a prespecified inclination of the machine frame or milling drum transverse to the advance direction of the road milling machine.

EP 0 836 659 B1 describes a road milling machine which comprises a machine frame supported by two front and rear running gear units. The front running gear units are fastened to the machine frame in such a way that they can follow changes in the transverse inclination of the road surface in opposite directions and to the same extent. This arrangement is also referred to as a full-floating axle. A road milling machine having a full-floating axle is also known from DE 102 10 763 A1.

EP 1 855 899 B1 describes a road milling machine, the front and rear running gear units of which are force-coupled to one another in such a way that the front left-hand running gear unit and the rear right-hand running gear unit are height-adjustable in the same direction and in the opposite direction to the front right-hand running gear unit and the rear left-hand running gear unit. The forced coupling of the running gear units can be effected mechanically or hydraulically.

The traffic surfaces to be machined can have different profiles, wherein the transverse inclination can change. In a right-hand curve the road surface is inclined to the right in the direction of travel relative to the horizontal, and in a left-hand curve it is inclined to the left. A road can be inclined to the one side or the other side on a straight route portion. Consequently, the transverse inclination of a road can change over the course of the route.

The full-floating mounting of at least the front left-hand and right-hand running gear units of a substrate milling machine has the advantage that the substrate milling machine has improved stability. The full-floating mounted front running gear units standing on the unmachined substrate can follow transverse inclinations of the route portion of the traffic area that is to be machined.

A levelling device for a road milling machine is known from DE 10 2006 020 293 A1, which, on the left-hand and the right-hand side of the road milling machine, in each case provides a sensor for capturing the actual value of the milling depth. The milling depth on the left-hand and the right-hand side of the machine can be controlled as a function of the deviation of the measured actual values from the target values.

The invention relates in particular to a milling process, also referred to as copy-milling, in which a road surface layer of the same thickness (milling depth) is to be milled off at each point of the substrate to be machined, wherein the transverse inclination of the surface of the substrate relative to the horizontal is not changed, i.e. is to be copied, during milling. If, for example in the case of a road having a transverse inclination to the right, the road surface is to be milled off, wherein the road milling machine is to travel on the right (right-hand traffic), the milling drum must penetrate the roadway surface with a prespecified milling depth, wherein the milling drum or the machine frame on which the milling drum is attached must be inclined to the right by a prespecified angle relative to the horizontal.

At the beginning of the milling work, the substrate milling machine is positioned on the roadway. The lifting columns assigned to the running gear units are then retracted so that the machine frame is lowered with the milling drum. The machine frame is lowered until the milling tools of the rotating milling drum just touch the road surface. This process is referred to as “scratching”. The milling drum should be oriented parallel to the road surface, thereby determining the orientation of the machine frame.

If, for example, a route portion that is on the right-hand side in the direction of travel and is outside of the roadway is to be milled, the milling depth can still be measured on the left-hand side of the milling drum in the working direction. For this purpose, the distance between the unmachined substrate and a reference point relating to the machine frame of the road milling machine, which reference point is located on the left-hand side of the milling drum, is measured. However, a suitable reference surface is not present on the right-hand side of the construction machine in the working direction if there is a road trench or an embankment on the right-hand side. For this reason, a distance measurement at the right-hand outer edge of the roadway cannot be carried out easily. For a distance measurement on the right-hand side, a guide wire could be laid, but this proves to be relatively complicated in practice.

In the present case, the milling depth on the right-hand side of the substrate milling machine could also be controlled using the transverse inclination of the machine frame or milling drum relative to the horizontal that can be detected by means of an inclination sensor. An inclination of the substrate milling machine to the right results in an increase in the milling depth on the right-hand side of the substrate milling machine, and an inclination of the milling machine to the left results in a reduction in the milling depth on the right-hand side of the substrate milling machine. However, in order to be able to set the milling depth on the right-hand side by changing the transverse inclination of the machine frame, the inclination that is to be set (target value) would have to be known over the entire course of the route. For this reason, before the start of milling work, additional information (data) would have to be supplied regarding the course of the route portion to be machined. In practice, this requires walking the route portion that is to be machined, measuring the transverse inclination and applying appropriate markers to the roadway.

For the case described above, DE 10 2018 127 222 B4 provides a controller which controls the lifting columns assigned to the running gear units as a function of distance values captured with a first distance sensor and a second distance sensor, which values in each case measure the distance between a reference point and the unmachined substrate surface. The reference points of the first and second distance sensors lie in a vertical plane which is cut orthogonally by the longitudinal axis of the machine frame and in which the axis of the milling drum is preferably also located.

### SUMMARY ΔF THE DISCLOSURE

The object of the invention is to provide a substrate milling machine which allows an exact machining of the substrate, in particular allows an exact machining of the substrate without any provision before the milling work of additional information about the transverse inclination of the substrate surface, even when no suitable reference surface for determining distance values is present on one side of the route portion that is to be machined. Furthermore, it is an object of the invention to specify a corresponding method for controlling a substrate milling machine, which, even in the absence of a suitable reference surface on one side of the substrate milling machine, allows an exact machining of the substrate, in particular without any provision before the milling work of additional information about the transverse inclination of the substrate surface. In this case, an exact machining of the substrate should also be possible when the transverse inclination of the route portion that is to be machined changes over the course of that route portion, for example in a curve or during the transition from a straight route portion into a curve or vice versa.

These objects are achieved according to the invention by the features of the independent claims. The subject-matter of the dependent claims relates to advantageous embodiments of the invention.

The substrate milling machine according to the invention has a machine frame which is supported by an undercarriage which has a front left-hand running gear unit and a front right-hand running gear unit and a rear left-hand running gear unit and a rear right-hand running gear unit, and has a milling drum arranged on the machine frame. The substrate milling machine according to the invention provides two different embodiments. Both embodiments may be described as having the front running gear units operably associated with each other such that a raising of the front left-hand running gear unit causes a lowering of the front right-hand running gear unit, and a lowering of the front left-hand running gear unit causes a raising of the front right-hand running gear unit.

In one embodiment, lifting columns assigned to both the front and the rear running gear units are provided, which lifting columns can each be retracted or extended in order to raise or lower the front and rear running gear units relative to the machine frame. The lifting columns of the front running gear units are force-coupled to one another in such a way that a raising of the front left-hand running gear unit causes a lowering of the front right-hand running gear unit, and a lowering the front left-hand running gear unit causes a raising of the front right-hand running gear unit, wherein the raising and the lowering take place by the same amounts.

In the other embodiment, lifting columns are assigned only to the rear running gear units, which lifting columns can each be retracted or extended in order to raise or lower the rear running gear units relative to the machine frame. The front running gear units are connected to the machine frame in the manner of a full-floating mounting in such a way that a raising of the front left-hand running gear unit causes a lowering of the front right-hand running gear unit by the same amount, and a lowering of the front left-hand running gear unit causes a raising of the front right-hand running gear unit by the same amount. This full-floating mounting can be effected, for example, using a full-floating axle system to which the front running gear units are fastened.

If reference is made below to “a” measuring device, this does not mean that further measuring devices cannot be present. If a control is referred to below as a function of “a” signal, this does not rule out the possibility that the control cannot still take place as a function of further signals.

Furthermore, a distance measuring device is provided which is designed in such a way that the distance between a reference point relating to the machine frame and the substrate surface is measured, wherein distance values are determined by the distance measuring device. Distance values are understood in this context to mean all variables correlating with the distance. These distance values can be transmitted or processed as analog signals or data sets.

Furthermore, the substrate milling machine according to the invention has a controller which is configured in such a way that control signals (data or data sets) for the lifting columns of the running gear units are generated, wherein the lifting columns of the running gear units are designed in such a way that the running gear units are retracted or extended as a function of the control signals in order, for example, to be able to set the milling depth or the transverse inclination.

The substrate milling machine according to the invention is characterised by a transverse inclination sensor system which is designed in such a way that the position of the front left-hand running gear unit and/or of the front right-hand running gear unit, which stand on the unmachined substrate, is detected with respect to the machine frame, and transverse inclination values describing the transverse inclination of the substrate surface transverse to the working direction of the substrate milling machine with respect to the machine frame are determined from the position of the front left-hand running gear unit and/or of the front right-hand running gear unit. In contrast to a conventional transverse inclination sensor, which measures the inclination of the machine frame or of the milling drum relative to the horizontal, the transverse inclination sensor system according to the invention allows detection of the transverse inclination of the unmachined substrate, on which the front running gear units stand, which possibly changes over the course of the route. The transverse inclination sensor system therefore functions as a transverse inclination sensor system for detecting the transverse inclination of the course of the route. In this context, transverse inclination values are understood to mean all variables that correlate with the transverse inclination. These transverse inclination values can be transmitted or processed as analog signals or data or data sets. To determine the transverse inclination, the lifting position of the lifting column assigned to the front left-hand running gear unit and/or the lifting position of the lifting column assigned to the front right-hand running gear unit can be detected. Due to the forced coupling of the lifting columns, it can suffice to detect only the lifting position of one of the two lifting columns, since the lifting position of one lifting column can be deduced from the lifting position of the other lifting column. In the case of a full-floating axle system, for example, the angular position of a full-floating axle can be detected in order to detect the position of a running gear unit.

The controller interacts with the distance measuring device and the transverse inclination sensor system in such a way that the controller generates the control signals for controlling the lifting columns of the rear running gear units as a function not only of the distance values but also of the transverse inclination values, wherein the lifting columns at least the two rear running gear units are controlled in such a way that the rotational axis of the milling drum is oriented substantially parallel to the substrate surface to be machined. In this case, the lifting column of the left-hand (right-hand) running gear unit in the working direction can take place as a function of the distance values and the lifting column of the right-hand (left-hand) running gear unit in the working direction of the construction machine can take place as a function of the transverse inclination values. The only decisive factor is that the transverse inclination values are captured and are taken into account when controlling the rear running gear units. This does not rule out the possibility that even further variables can be taken into account in the control.

The transverse inclination sensor system thus allows “scanning” of the substrate surface of the unmachined substrate, the transverse inclination of which can be assumed as a target value for the transverse inclination of the machined substrate, so that the surface of the subsequently milled substrate has the same transverse inclination as the surface of the substrate that has not yet been milled (copy-milling). For this reason, it is not necessary to survey the traffic area before starting the milling work and nor is prespecification of the data necessary, for example, by attaching markers to the roadway.

One embodiment of the substrate milling machine according to the invention provides that the controller is configured in such a way that the transverse inclination values determined by the transverse inclination sensor system during the advance of the substrate milling machine are monitored, wherein after the determination of a change in the transverse inclination between successive waypoints of the distance travelled by the substrate milling machine, at least one of the lifting columns of the rear running gear units is retracted or extended by an amount such that the rotational axis of the milling drum is again oriented substantially parallel to the substrate surface to be machined. One of the two rear running gear units is thus adjusted in height in such a way that a change in the transverse inclination of the road to be milled is compensated again. The control is preferably carried out continuously, wherein the distance between successive waypoints should be as short as possible, which in the case of a digital controller is determined by the clock frequency. However, it is also possible in principle to correct the setting of the running gear units at specific (longer) time intervals or after specific (longer) distances have been travelled.

In the case of the substrate milling machine according to the invention, the milling drum can be arranged on the machine frame between the front and rear running gear units in the working direction, for example in the center of the machine frame, or between the rear running gear units. In either arrangement, the milling drum is arranged on the machine frame behind the front running gear units in the working direction. For this reason, when the substrate milling machine is advancing between the time point or the time interval of the “scanning” of the road surface using the transverse inclination sensor system and the time point or the time interval of the milling of the road, a temporal offset results. However, it has emerged in practice that the control suffices even without this temporal offset being taken into account. However, a particularly preferred embodiment provides that the controller is configured in such a way that, after the determination of a change in the transverse inclination between successive waypoints, one of the lifting columns of the rear running gear units is retracted or extended only after a prespecified time interval has elapsed or after a prespecified distance has been travelled. The controller can be configured in such a way that the determination of the prespecified time interval or the prespecified distance takes place as a function of the advance speed of the substrate milling machine.

For possibly subsequent (temporally offset) processing of the data, the controller can have a memory for storing transverse inclination values determined by the transverse inclination value detection device at successive points in time and/or at successive waypoints. The route portion travelled by the substrate milling machine can be detected, for example, by an odometer, wherein the transverse inclination values captured at the individual waypoints are saved to the memory so that the transverse inclination values are temporarily stored. The transverse inclination values can then be read from the memory at the time when the milling drum reaches the location where the respective transverse inclination values were captured, and said values can be used to correct the lifting position of the relevant lifting column.

The distance measuring device can have at least one distance sensor, which is a contact distance sensor or a contactless distance sensor. Such distance measuring systems belong to the prior art. For example, the edge protection of a road milling machine, which is generally provided next to the milling drum, can also function as a contact sensor of the distance measuring device. For example, optical or inductive or capacitive distance sensors or ultrasonic distance sensors can be used as contactless distance sensors. The distance measurement can be a point measurement. In practice, however, known distance sensors provide the measurement in relation to a surface, for example a circular area in the case of an ultrasonic sensor or the contact area of an edge protector. In this context, multiplex is understood to mean an arrangement of a plurality of (three, five, seven) distance measuring devices offset along the direction of travel and the use of their average value as a distance value.

The distance measuring device can be designed in such a way that the reference point relating to the machine frame lies on a longitudinal side of the machine frame, preferably laterally next to the milling drum, particularly preferably in a vertical plane in which the milling drum axis lies.

In order to determine the transverse inclination values, the transverse inclination sensor system can have a left-hand sensor in relation to the working direction, which covers left-hand distance values in relation to the position of the front left-hand running gear unit with respect to the machine frame, and a right-hand sensor in relation to the working direction, which covers right-hand distance values in relation to the position of the front right-hand running gear unit with respect to the machine frame. The distance values can be obtained, for example, from the lifting positions of the lifting columns assigned to the front running gear units, wherein the lifting positions of the lifting columns can be detected by the known distance sensors. Separate measuring devices or measuring devices integrated in lifting columns belong to the prior art.

If, for example in the case of a road, the substrate milling machine according to the invention is to mill the right-hand roadway side or a right-side roadway portion (right-hand traffic), and a suitable reference surface is not available on the right-hand side of the road, the distance measuring device is then unable to measure the distance between a reference point lying at the height of the milling drum and the road surface on the right-hand side of the machine frame, in order to be able to set the milling depth using the rear right-hand lifting column.

For this application case, the controller can be configured in such a way that, as a function of the determined transverse inclination values, the lifting column of the rear right-hand running gear unit is retracted when the left-hand distance value decreases and the right-hand distance value increases during the advance of the substrate milling machine, and the lifting column of the rear right-hand running gear unit is extended when the left-hand distance value increases and the right-hand distance value decreases during the advance of the substrate milling machine, so that the rotational axis of the milling drum remains substantially parallel to the surface of the unmachined substrate during the advance of the substrate milling machine. The milling depth is set using the lifting column of the rear left-hand running gear unit, wherein its lifting position is controlled as a function of the determined distance values of the distance measuring device. Analogously, the milling depth can also be controlled using the lifting column of the rear right-hand running gear unit as a function of the determined distance values, and the transverse inclination can be controlled using the lifting column of the rear left-hand running gear unit as a function of the determined transverse inclination values.

The controller can be configured in such a way that, during the advance of the substrate milling machine, the lifting position of the lifting column of the rear right-hand running gear unit is set or adjusted in such a way that the difference between the distance values measured with the left-hand distance sensor and with the right-hand distance sensor is minimised. In this embodiment, the transverse inclination of the machine frame in relation to the horizontal does not need to be determined.

In addition, the rear right-hand running gear unit can be controlled in such a way that transverse inclination values describing the transverse inclination of the substrate surface transverse to the working direction of the substrate milling machine with respect to a reference plane of the machine frame are determined from the left-hand and right-hand distance values, and transverse inclination target values are determined from the transverse inclination values and the machine frame inclination values for successive waypoints, which transverse inclination target values are compared with the machine frame inclination values, wherein during the advance of the substrate milling machine, the lifting position of the lifting column of the rear right-hand running gear unit is set in such a way that the difference between the transverse inclination target values and the machine frame inclination values is minimised.

An embodiment of the substrate milling machine according to the invention is described in detail below with reference to the drawings.

### BRIEF DESCRIPTION ΔF THE DRAWINGS

In the drawings:

FIG. 1 is a side view of an embodiment of the substrate milling machine according to the invention,

FIG. 2 is a simplified schematic view of the individual components of the substrate milling machine,

FIG. 3A is a plan view of a road which is being machined by the substrate milling machine, wherein the substrate milling machine is machining a route portion on the outside of the roadway,

FIG. 3B shows the transverse inclination profile of the road that is to be machined,

FIG. 4A is a rear view of the substrate milling machine during milling of the road surface, in which the milled substrate surface and the rear running gear units of the substrate milling machine are shown, wherein the substrate milling machine is located at a first position,

FIG. 4B is a view of the front running gear units standing on the non-milled substrate and the lifting position of the lifting columns assigned to the front running gear units in the first position,

FIG. 4C is a simplified schematic view of a further embodiment of a full-floating mounting of the front running gear units,

FIG. 5A is a rear view of the substrate milling machine during milling of the road surface, wherein the substrate milling machine is located at a second position,

FIG. 5B is a view of the front running gear units and their lifting columns,

FIG. 6A is a rear view of the substrate milling machine when milling the road surface, wherein the substrate milling machine is located at a third position,

FIG. 6B is a view of the front running gear units and their lifting columns,

FIG. 7A is a rear view of the substrate milling machine during milling of the road surface, wherein the substrate milling machine is located at a fourth position,

FIG. 7B is a view of the front running gear units and their lifting columns,

FIG. 8A is a rear view of the substrate milling machine during milling of the road surface, wherein the substrate milling machine is located at a fifth position,

FIG. 8B is a view of the front running gear units and their lifting columns,

FIG. 9A is a rear view of the substrate milling machine during milling of the road surface, wherein the substrate milling machine is located at a sixth position,

FIG. 9B is a view of the front running gear units and their lifting columns,

FIG. 10A is a rear view of the substrate milling machine during milling of the road surface, wherein the substrate milling machine is located at a seventh position,

FIG. 10B is a view of the front running gear units and their lifting columns,

FIG. 11A is a rear view of the substrate milling machine during milling of the road surface, wherein the substrate milling machine is located at an eighth position,

FIG. 11B is a view of the front running gear units and their lifting columns,

FIG. 12A is a rear view of the substrate milling machine during milling of the road surface, wherein the substrate milling machine is located at a ninth position,

FIG. 12B is a view of the front running gear units and their lifting columns,

FIG. 13 shows a table with numerical values illustrating the lifting movement of the lifting columns of the front running gear units,

FIG. 14 shows a block diagram illustrating an embodiment of the controller of the substrate milling machine, and

FIG. 15 shows a block diagram illustrating a further embodiment of the controller of the substrate milling machine.

### DETAILED DESCRIPTION

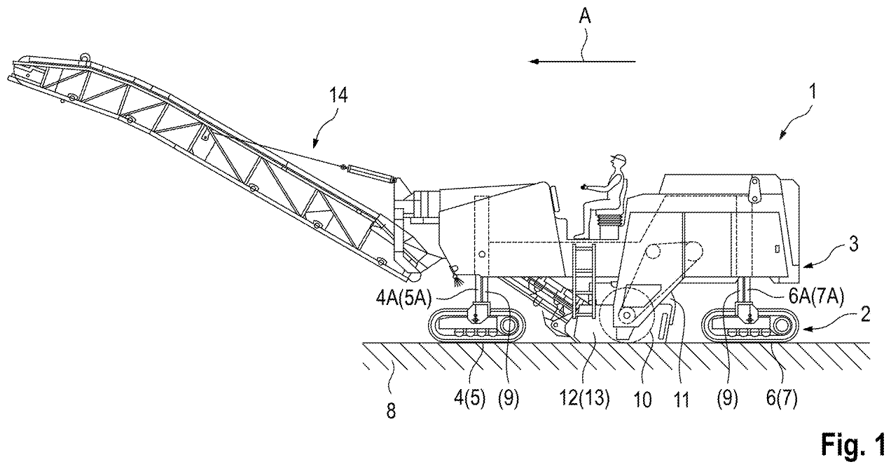

FIG. 1 is a side view of an embodiment of a self-propelled substrate milling machine 1 for milling road surface layers. The substrate milling machine 1 has an undercarriage 2 and a machine frame 3. The undercarriage 2 has a front left-hand running gear unit 4 and a front right-hand running gear unit 5 and a rear left-hand running gear unit 6 and a rear right-hand running gear unit 7 in the working direction A. Track units or wheels can be provided as running gear units.

In order to adjust the height and/or inclination of the machine frame 3 relative to the surface of the substrate (road surface), the substrate milling machine has lifting columns 4A, 5A, 6A, 7A which are assigned to the individual running gear units 4, 5, 6, and on which the machine frame 3 is carried. The lifting columns 4A, 5A, 6A, 7A each have a piston/cylinder arrangement 9 for adjusting the running gear units.

The substrate milling machine 1 further has a milling drum 10 equipped with milling tools, which is arranged on the machine frame 3 between the front and rear running gear units 4, 5, 6, 7 within a milling drum housing 11, which is closed on the longitudinal sides by a left-hand and a right-hand edge protector 12, 13.

By retracting and extending the piston/cylinder arrangements 9 of the lifting columns 4A, 5A, 6A, 7A, the height and/or inclination of the machine frame 3 and of the milling drum 10 arranged on the machine frame can be set relative to the substrate surface 8. For the removal of the milled road surface layer, a conveyor device 14 having a conveyor belt is provided.

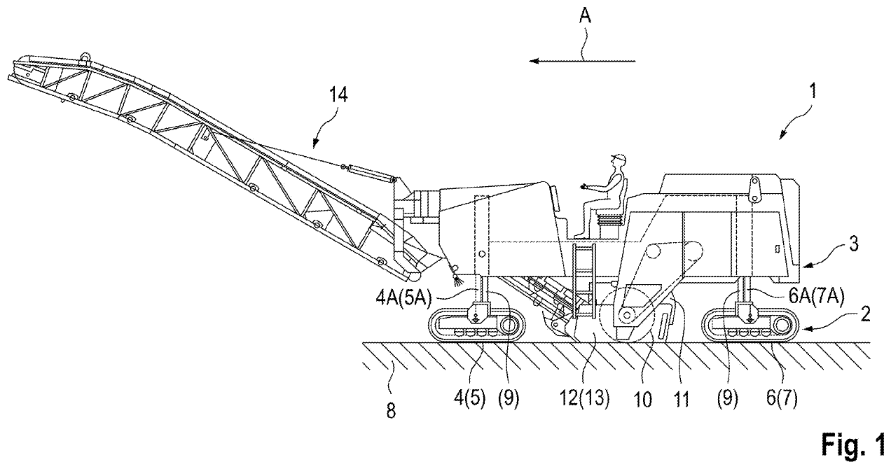

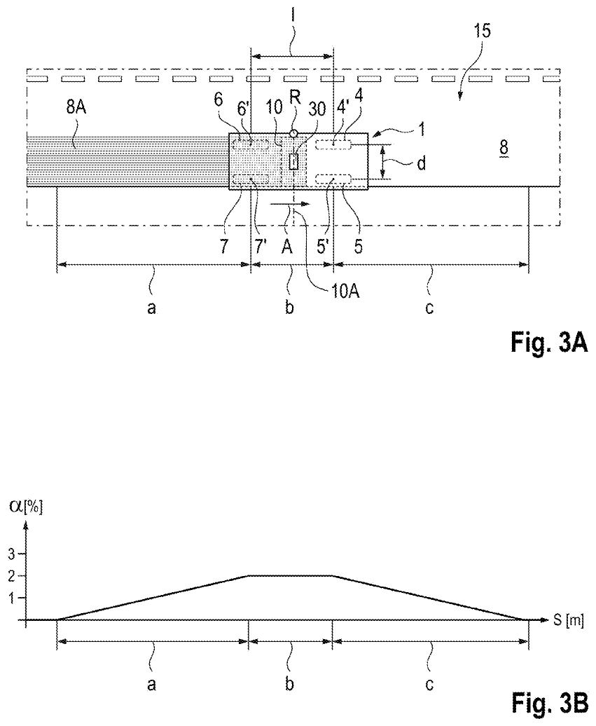

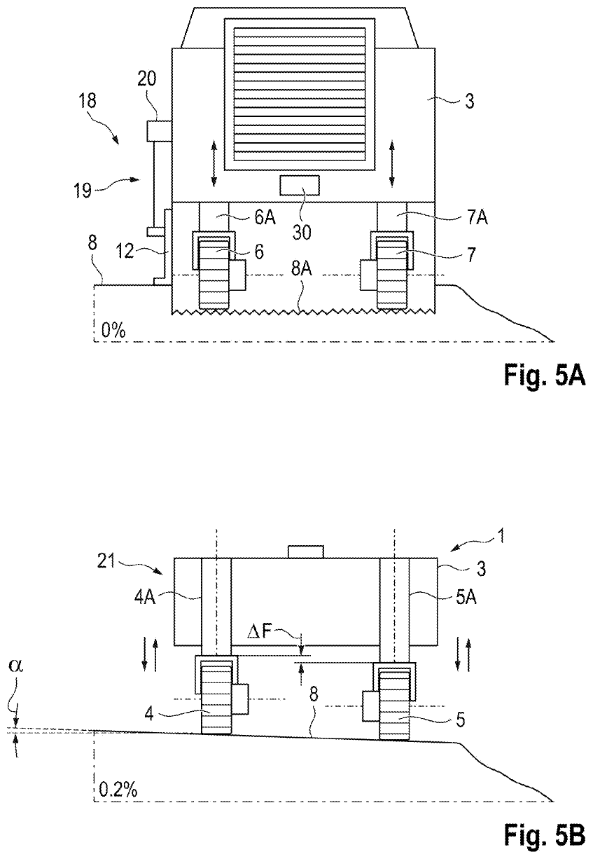

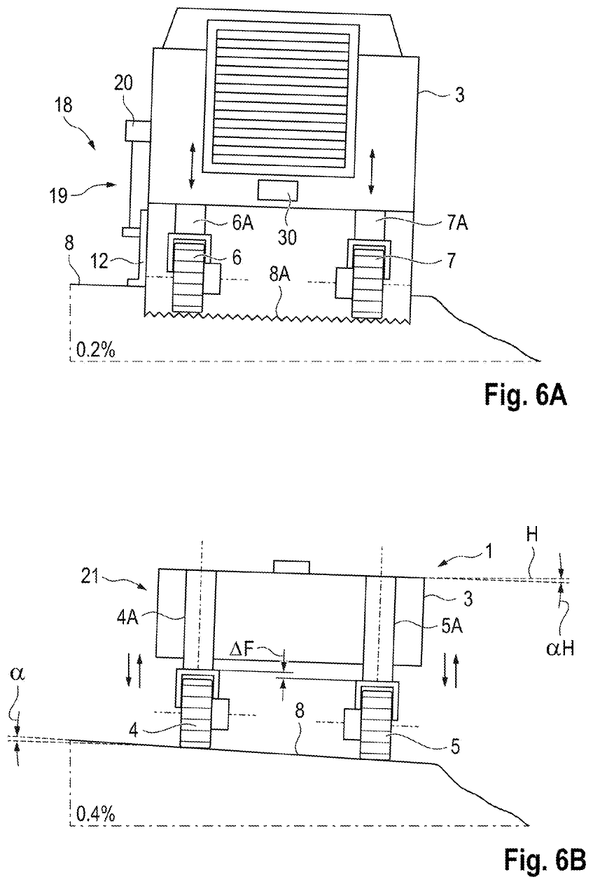

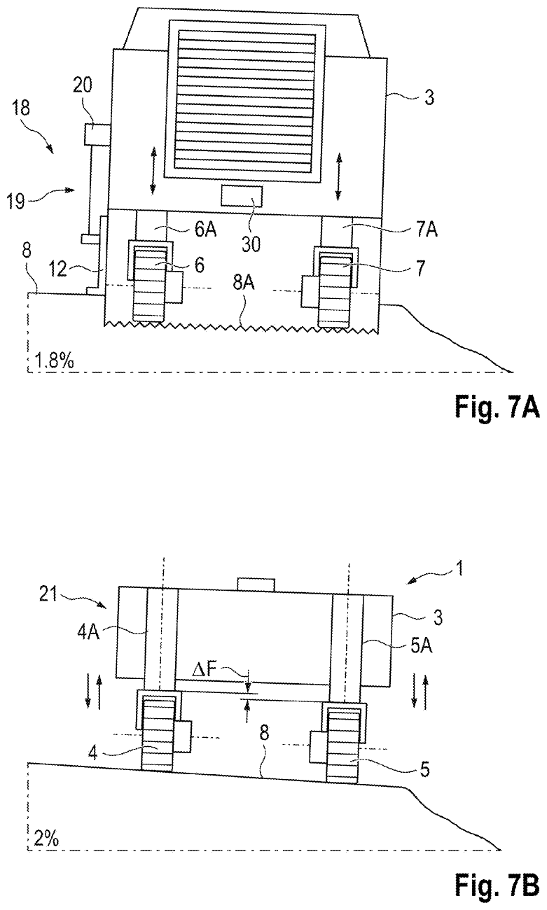

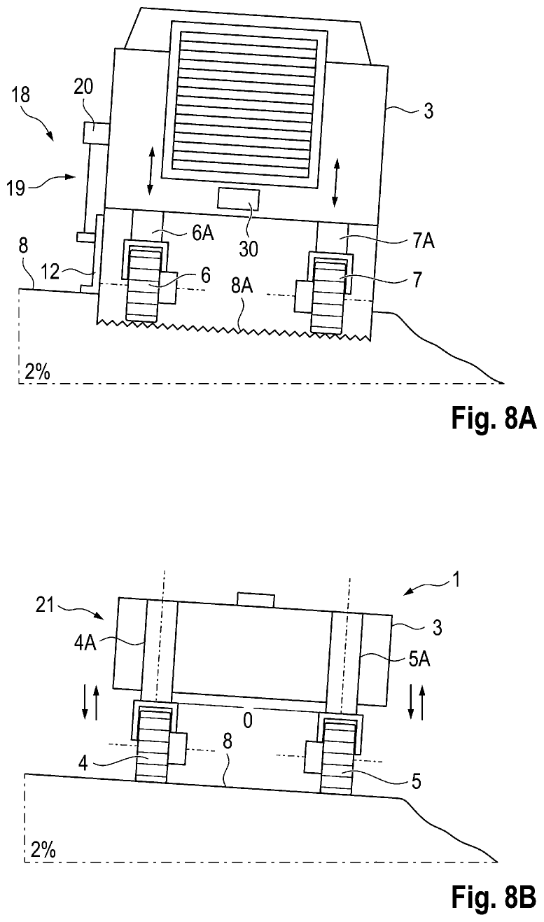

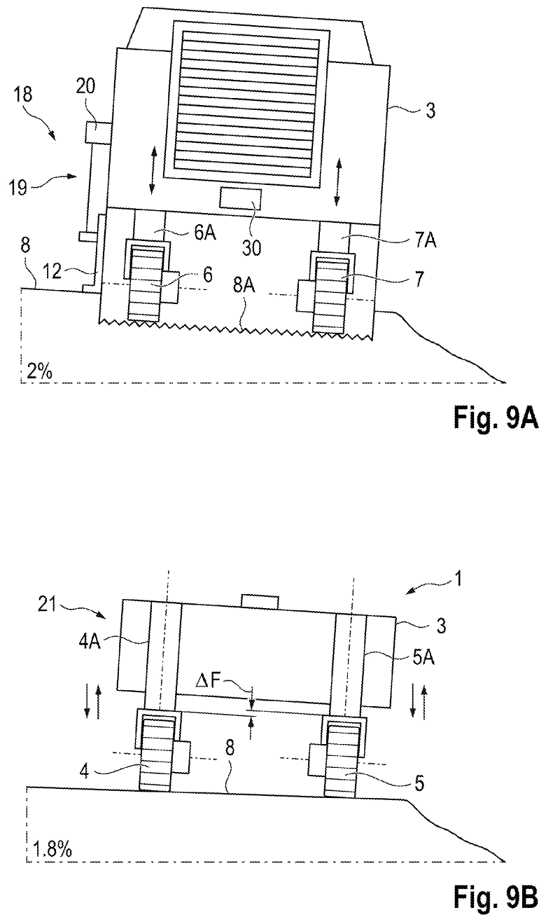

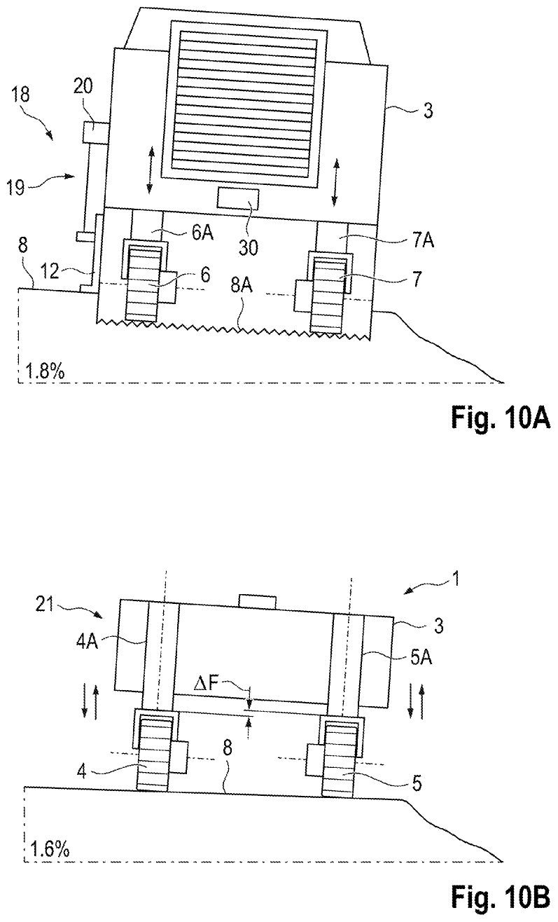

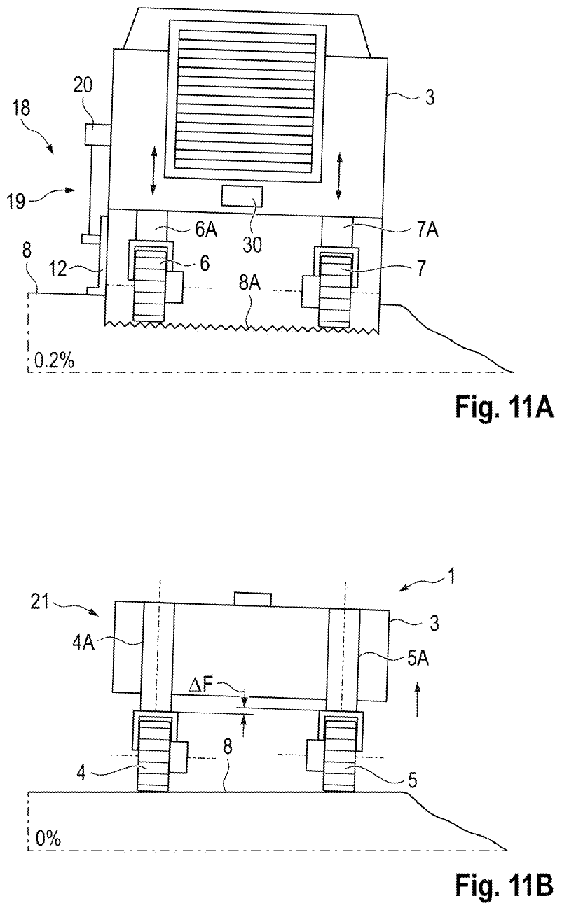

FIG. 2 is a simplified schematic view of the individual components of the substrate milling machine 1. FIG. 4A to 12A show a rear view of the substrate milling machine 1 during milling of the road surface, in which the original substrate surface 8 and the milled substrate surface 8A and the rear running gear units 6, 7 of the substrate milling machine 1 are shown, and FIG. 4B to 12B show a view of the front running gear units 4, 5 standing on the non-milled substrate and the lifting position of the lifting columns 4A and 5A assigned to the front running gear units. The figures designated “A” and “B” (e.g. FIG. 4A and FIG. 4B) show the substrate milling machine 1 in each case at the same point in time, at which, as seen in the longitudinal direction of the machine frame 3 (working direction), the contact points 4′, 5′ of the front running gear units 4, 5 are located at a distance I (wheelbase) ahead of the contact points 6′, 7′ of the rear running gear units 6, 7.

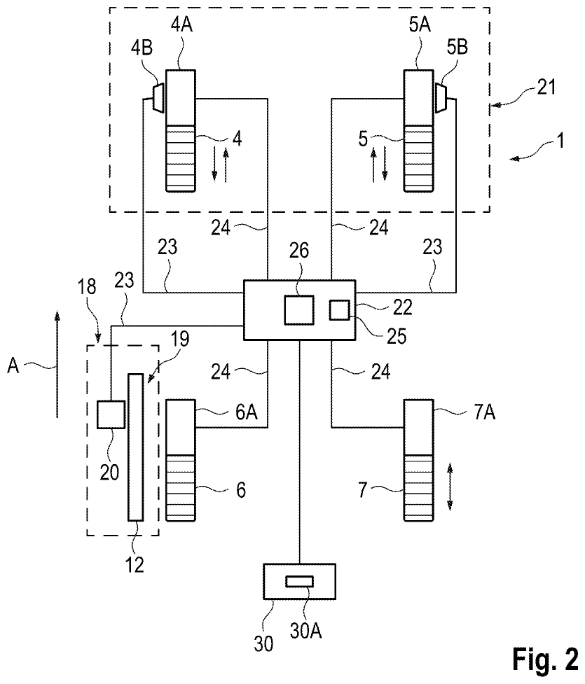

FIG. 3A is a highly simplified schematic plan view of the substrate milling machine 1, wherein the substrate milling machine 1 is milling a road surface layer from a right-hand route portion of a road 15. The individual components are provided with the same reference signs in the drawings.

The front running gear units 4, 5 of the substrate milling machine 1 are force-coupled to one another in such a way that a raising of the front left-hand running gear unit 4 causes a lowering of the front right-hand running gear unit 5, and a lowering of the front left-hand running gear unit 4 causes a raising of the front right-hand running gear unit 5. Such a coupling of the running gear units can be effected mechanically or hydraulically. A mechanical and hydraulic coupling of the running gear units is described, for example, in DE 196 17 442 C1.

FIG. 4C shows an alternative embodiment of a full-floating mounting of the front left-hand and right-hand running gear units 4, 5. The two running gear units 4, 5 are fastened to a full-floating axle 16, which is mounted so as to float about a longitudinal axis 17 of the machine frame 3. Such a full-floating mounting is described, for example, in DE 102 10 763 A1. A full-floating mounting like that of FIG. 4C is accomplished by mechanical linkage as opposed to being accomplished by hydraulic interaction. A full-floating mounting like that of FIG. 4C is also sometimes referred to as a pendulum axle or as a walking beam axle.

In the present embodiment, the retraction (extension) of the lifting column 6A (piston/cylinder arrangement) of the rear left-hand running gear unit 6 leads to a raising (lowering) of the left-hand running gear unit 6 in relation to the machine frame 3, as a result of which the machine frame is lowered (raised) on the left-hand side, and the retraction (extension) of the lifting column 7A (piston/cylinder arrangement) of the rear right-hand running gear unit 7 leads to a raising (lowering) of the right-hand running gear unit 7 in relation to the machine frame 3, as a result of which the machine frame 3 is lowered (raised) on the right-hand side.

The substrate milling machine 1 has a distance measuring device 18 which is designed in such a way that the distance between a reference point R (FIG. 3A) relating to the machine frame 3 and the substrate surface 8 is measured. In the present embodiment, the distance measuring device 18 comprises a distance sensor 19 which is arranged laterally next to the milling drum 10 on the left-hand side of the machine frame 3 in the working direction, between the front and rear running gear units (FIG. 3A). In the present embodiment, this distance sensor 19 is a contact distance sensor which makes use of the left-hand edge protector 12, to which a draw-wire sensor 20 is fastened (FIG. 4A). If the edge protector 12 is mounted so as to be height-adjustable via two hydraulic cylinders arranged offset in the direction of travel, the height of the edge protector can also be detected by means of a displacement sensor system integrated in the hydraulic cylinder instead of by means of a draw-wire sensor. The edge protector 12 rests on the substrate surface 8. The draw-wire sensor 20 measures the distance by which the edge protector 12 moves up and down. Consequently, the distance between the reference point R and the substrate surface 12 on which the edge protector 12 rests can be measured.

Furthermore, the substrate milling machine 1 has a transverse inclination sensor system 21 which is designed in such a way that at each waypoint the transverse inclination of the machine frame 3 or of the rotational axis of the milling drum 10A in relation to the surface of the substrate can be detected from the lifting position of the lifting columns 4A, 5A of the front running gear units 4, 5 or, in the case of the alternative embodiment, from the position of the full-floating axle 16. The respective waypoints correspond to the contact points of the front running gear units. In the present embodiment, the front left-hand running gear unit 4 comprises a left-hand distance sensor 4B, which determines left-hand distance values FL in relation to the position of the front left-hand running gear unit with respect to the machine frame 3, and a right-hand distance sensor 5B, which determines right-hand distance values FR in relation to the position of the front right-hand running gear unit 5 with respect to the machine frame 3. The distance sensors 4B, 5B can be integrated displacement measuring systems of the lifting columns 4A, 5A assigned to the running gear units 4, 5.

Furthermore, the substrate milling machine 1 has a controller 22 which can form an independent assembly or can be at least partially a component of the central control and computing unit of the construction machine. The controller 22 can comprise, for example, a general processor, a digital signal processor (DSP) for continuous processing of digital signals, a microprocessor, an application-specific integrated circuit (ASIC), an integrated circuit (FPGA) consisting of logic elements, or other integrated circuits (IC) or hardware components, in order to carry out the control of the lifting columns and the capture and evaluation of the measured values. A data processing program (software) can run on the hardware components. A combination of the various components is also possible.

The controller 22 is connected via signal lines 23 or data lines to the draw-wire sensor 20 of the distance measuring device 18 and to the distance sensors 4B, 5B of the transverse inclination sensor system 21 and generates control signals for the lifting columns 4A, 5A, 6A, 7A. The lifting columns 4A, 5A, 6A, 7A are designed in such a way that their piston/cylinder arrangements are retracted or extended as a function of the control signals, so that the running gear units 4, 5, 6, 7 are raised or lowered relative to the machine frame 3. The control signals are transmitted via control or data lines 24.

The controller 22 is configured in such a way that the steps described below of the method according to the invention for controlling the substrate milling machine are carried out.

In the present embodiment, a road surface layer is to be milled off a road which, over the course of the route, has the transverse inclination α shown in FIG. 3A. The thickness of the milled-off road surface layer determines the milling depth. In the present embodiment, the route portion under consideration is a right-hand curve, the transverse inclination of which increases toward the middle of the curve, remains constant at the middle of the curve and decreases again after the middle of the curve. It is assumed that the route portion of the road has a portion a having a uniformly increasing slope (80 m), a portion b having a constant slope (8 m) and a portion c having a uniformly decreasing slope (80 m). The distance I between the assumed contact points 4′, 6′ and 5′, 7′ of the front and rear running gear units 4, 5, 6, 7 in the longitudinal direction of the substrate milling machine is 8 m, wherein the distance thereof from the milling drum 10 arranged centrally between the running gear units 4, 5, 6, 7 is 4 m. The distance d between the contact points 4′, 5′ of the front running gear units 4, 5 in the transverse direction is 1.6 m.

The individual method steps are described below with reference to FIGS. 4A and 4B to 12A and 12B.

At the beginning of the milling work, the distance measuring device 18 is adjusted, in particular the zero point is set. In order to set the zero point, in the case of the horizontal orientation of the substrate milling machine, the lifting columns 4A, 5A, 6A, 7A are adjusted such that the milling drum 10 just touches the substrate surface 8 with the cylindrical lateral surface defined by the tips of the milling tools. For this purpose, the lifting columns 4A, 5A, 6A, 7A are retracted until the milling tools of the rotating milling drum 10 begin to scratch the substrate. This process is also referred to as scratching. When the milling cutters touch the substrate surface 8, the distance measuring device 18 is set to zero. When the lifting columns 4A, 5A, 6A, 7A are retracted further and the milling drum 10 penetrates the substrate, negative distance values are determined. The amount of the distance values corresponds to the milling depth. In the present embodiment, a milling depth of 40 mm is set. For this purpose, the front left-hand running gear unit 4 together with the front right-hand running gear unit 5 is lowered by 40 mm (FL, FR), and the rear left-hand running gear unit 6 is lowered by 40 mm (RL) and the rear right-hand running gear unit 7 is lowered by 40 mm (RR) (FIG. 4A).

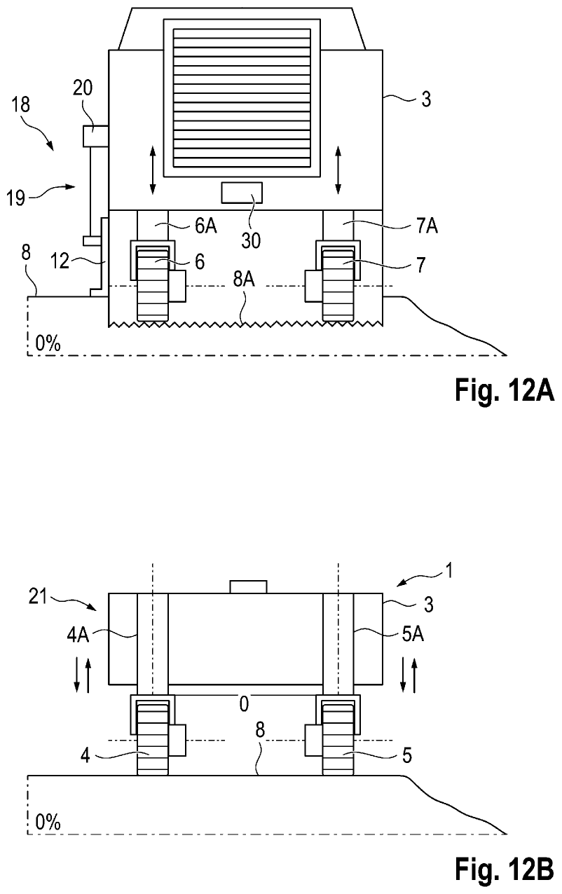

FIG. 13 shows a table having the corresponding numerical values for illustrating the lifting movements of the lifting columns 4A, 5A or of the running gear units 4, 5 for the individual positions of the substrate milling machine that are shown in FIGS. 4A and 4B to 12A and 12B. FIGS. 4A and 4B to 12A and 12B do not show all of the positions, since the lifting positions repeat due to the uniform course of the transverse inclination.

A first embodiment of the controller is described below.

During the advance of the road milling machine, the controller 22 continuously receives the distance values from the distance measuring device 18 and also the left-hand and right-hand distance values FL and FR from the left-hand and right-hand distance sensors 4B, 5B of the front left-hand and right-hand lifting columns 4A, 5A.

The controller 22 is configured in such a way that the difference ΔF between the left-hand and right-hand distance values FL and FR is continuously formed. If the difference ΔF between the left-hand and right-hand distance values FL and FR is equal to zero, the transverse inclination a of the non-milled substrate surface 8 relative to the machine frame 3 is equal to zero. If the difference ΔF is not equal to zero, the non-milled substrate surface 8 is inclined to the one side or the other side. The sign of the difference ΔF indicates the direction of inclination.

When the substrate milling machine 1 is advancing, the aim is that the surface 8A of the milled substrate corresponds to the surface 8 of the non-milled substrate in transverse inclination (copy-milling). For this reason, the machine frame 3 or the milling drum 10 is to be oriented during the advance of the machine in such a way that the frame or drum follows the transverse inclination α changing over the course of the route, i.e. the surfaces 8 or 8A are parallel.

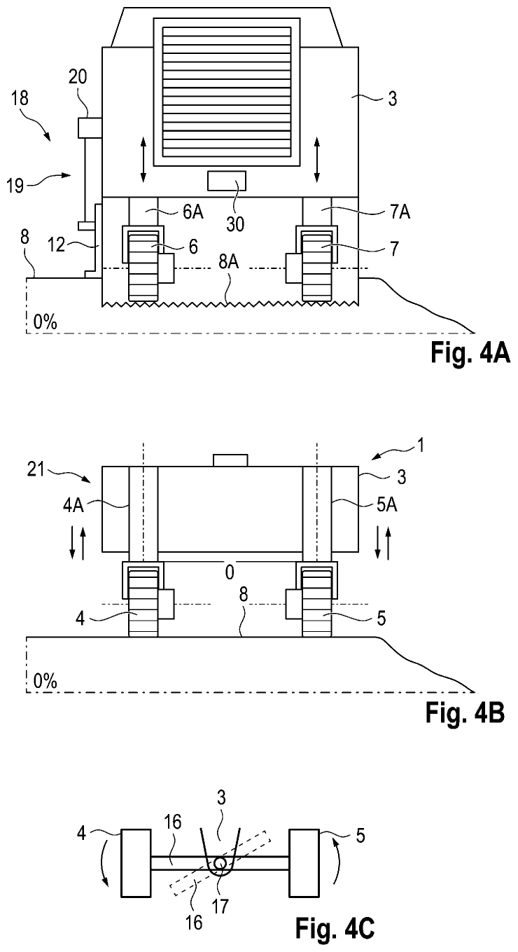

FIGS. 4A and 4B show the initial situation of the machine, wherein the transverse inclination a is zero (position 1). Then the difference ΔF of the left-hand and right-hand distance values FL and FR is equal to zero. FIGS. 5A and 5B show the position of the machine in which the rear running gear units are still standing on a portion which has a transverse inclination of 0%, while the front running gear units are already standing on a portion which has a transverse inclination of 0.2% (FIG. 5B). Since the front running gear units 4, 5 are coupled in opposite directions, the substrate milling machine can be described statically as a tripod. FIG. 5B shows that the rigid machine frame 3 has maintained its (horizontally oriented) position, and the lifting column 4A of the front left-hand running gear unit 4 has retracted by the left-hand distance value FL and the lifting column 5A of the front right-hand running gear unit 5 has extended by the right-hand distance value FR, which is why the difference OF between the left-hand and right-hand distance values FL and FR is not equal to zero. Since the difference ΔF is not equal to zero, it is possible to infer a change in the transverse inclination α. In this case, the transverse inclination α for the relevant waypoints has increased from 0 to 0.2%. The controller 22 now generates a control signal for the lifting column 7A of the rear right-hand running gear unit 7 in order to raise the rear right-hand running gear unit 7 relative to the machine frame 3 by an amount such that the machine frame 3 is lowered relative to the substrate surface 8 or 8A and the milling drum axis 10A is again oriented parallel to the substrate surface. This is the case when the difference ΔF between the left-hand and right-hand distance values FL and FR is zero again.

The controller 22 is configured such that the lifting of the rear right-hand lifting column 7A is controlled in such a way that the difference ΔF between the left-hand and right-hand distance values FL and FR is minimal when the machine is advancing, wherein the aim of the control is for the difference ΔF to be zero.

Analogously, the remaining figures show by way of example the increase or decrease in the transverse inclination by the same amount (0.2%) in the same route portions (8 m) from a rearward position to a forward position and also the maintenance of the transverse inclination.

During the control, it must be taken into account that the transverse inclination of the unmachined road is not detected at a waypoint at which the milling drum 10 is located, but at a waypoint which is only reached by the milling drum 10 after a certain distance has been travelled or after a certain time interval dependent on the advance speed of the road milling machine has elapsed. This offset can be taken into account in the control by reading the left-hand and right-hand distance values FL and FR and/or the difference ΔF between the left-hand and right-hand distance values FL and FR into a memory 25 of the controller 22 at specific points in time and/or at specific waypoints, in order to be able to evaluate the data later and to be able to use the data as a basis for the control. In order to define the waypoints and/or the points in time, an odometer or a timer can be provided. The distance values FL and FR can, for example, be marked with time and/or path markers and stored in the manner of a table. The controller 22 can be configured such that, in order to adjust the rear right-hand running gear unit 7 for the correct orientation of the machine frame 3 or to adjust the milling drum 10 to obtain the desired transverse inclination, those values which correspond to the instantaneous waypoint or time point of the milling drum 10 are read out from the memory.

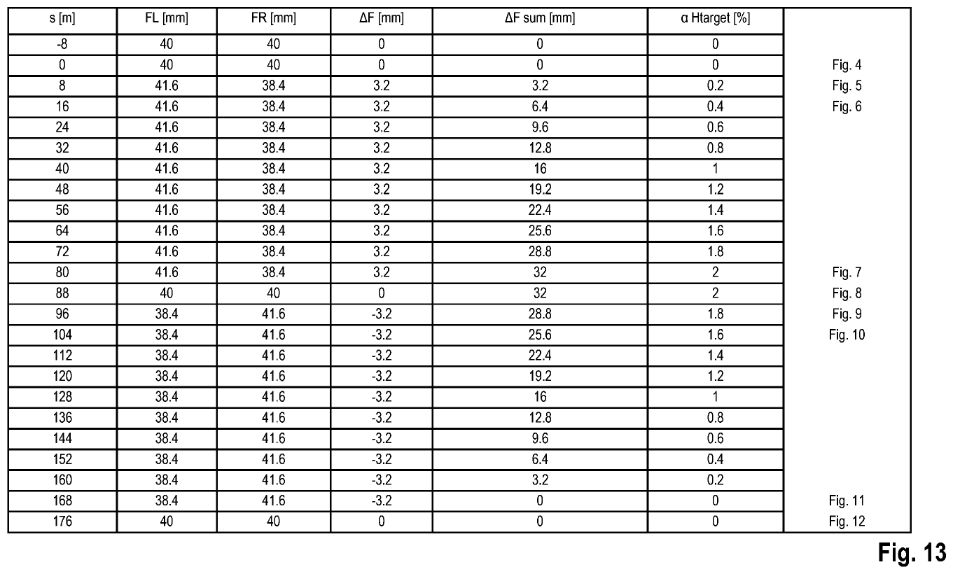

FIG. 14 shows a block diagram of a control loop having a closed-loop controller 26 for the control according to the invention.

The controlled variable X is the difference ΔFactual between the front left-hand and right-hand distance values FL and FR (ΔFactual=FL−FR), which are measured by means of the distance sensors 4B, 5B of the lifting columns 4A, 5A of the front left-hand and right-hand running gear units 4, 5. The aim of the control is to bring the controlled variable X to the reference variable W, i.e. to the value zero (ΔFtarget=FL−FR=0), with the aid of the manipulated variable Y which is influenced by an adjustment device, wherein the control deviation E=W−X should be as small as possible.

In the present control loop, the front running gear units 4, 5 with the lifting columns 4A, 5A and the distance sensors 4B, 5B represent the measuring device 29 of the control loop in order to determine ΔFactual=FLactual−FRactual (controlled variable X). The lifting column 7A of the rear right-hand running gear unit 7 represents the adjustment device 27 of the control loop. The control signal of the lifting column 7A of the rear right-hand running gear unit 7 represents the manipulated variable Y.

The controller 22 (closed-loop controller 26) is configured in such a way that the time-variable controlled variable X is influenced by the retraction or extension of the lifting column 7A of the rear right-hand running gear unit 7 in such a way that the control deviation E=W−X is as small as possible, i.e. ΔFactual=FLactual−FRactual is equal to zero. The control can also take into account disturbance variables Z acting on the controlled system 28.

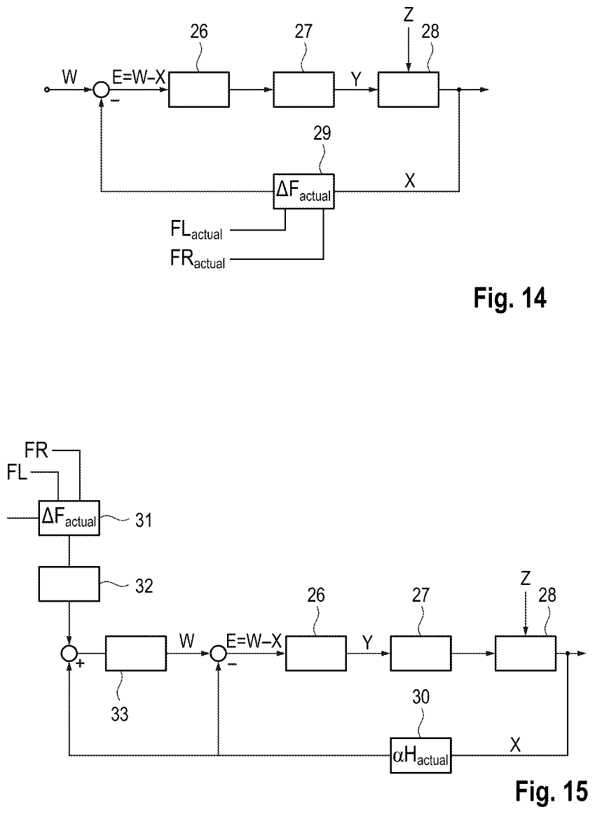

A further embodiment of the controller according to the invention is described below with reference to FIG. 15, which shows a block diagram of the alternative control system. During copy-milling, the transverse inclination of the milled road surface should correspond to the transverse inclination of the non-milled road surface. For this reason, in this embodiment, the transverse inclination αHtarget of the unmachined road in relation to the horizontal H is continuously determined as the reference variable W of the control during the advance of the substrate milling machine 1. For this purpose, the distance values FL and FR of the front left-hand and right-hand running gear unit 4, 5 are continuously measured using the left-hand and right-hand distance sensors 4B, 5B. These distance values are read into the memory 25 of the controller 22. For the present embodiment, the memory content of the memory 25 can be found in the table (FIG. 13).

At the beginning of the milling work (FIGS. 4A and 4B), the transverse inclination a of the machine frame 3 or of the axis 10A of the milling drum 10 relative to the unmachined horizontal substrate surface 8 or the horizontal H is equal to zero (ΔF=FL−FR=0, e.g. F=FR=40 mm). When the substrate milling machine has reached the position shown in FIGS. 5A and 5B, the front left-hand and right-hand running gear units 4, 5 will be on a route portion (FIG. 5B) on which the transverse inclination αH of the substrate surface 8 of the unmachined substrate is 0.2% relative to the horizontal (FIG. 5B). Analogously, corresponding inclination values result for the subsequent waypoints.

During the advance of the substrate milling machine, the left-hand distance values FL in relation to the position of the front left-hand running gear unit in the working direction with respect to the machine frame 3, and the right-hand distance values FR in relation to the position of the front right-hand running gear unit in the working direction with respect to the machine frame are determined. From the left-hand and right-hand distance values FL and FR, transverse inclination values αrel describing the transverse inclination α of the substrate surface 8 transverse to the working direction A of the substrate milling machine 1 with respect to a reference plane of the machine frame are determined in each case for successive waypoints sn. This reference plane is in this case a horizontal plane when the substrate milling machine is standing on a horizontal substrate and the left-hand distance value FL is equal to the right-hand distance value FR (ΔF=0).

When the substrate milling machine is located, for example, in the position shown in FIGS. 5A and 5B, the distance sensors 4A and 4B measure FL=41.6 mm and FR=38.4 mm. From FL=41.6 mm and FR=38.4 mm, the difference ΔF=41.6 mm−38.4 mm=3.2 mm is calculated. In the present embodiment, the distance d between the contact points 4′, 5′ of the front running gear units 4, 5 is 1600 mm. The transverse inclination αrel of the surface 8 of the non-milled substrate, on which the front running gear units 4, 5 are standing, relative to the machine frame 3 is calculated from ΔF and d (3.2 mm/1600 mm×100%=0.2%).

In the alternative embodiment, the substrate milling machine has an frame inclination sensor 30 having an inclination sensor 30A which is designed in such a way that the inclination αHactual of the machine frame 3 or of the rotational axis 10A of the milling drum 10 is measured relative to the horizontal H, and machine frame inclination values αHactual describing the inclination are determined. If the two running gear units 4, 5 are standing on an unmachined substrate, the surface of which lies in the horizontal H, and the lifting columns 4A, 5A have the same lifting position, the frame inclination sensor 30 measures an inclination αHactual=0 (FIG. 4B).

From the transverse inclination values αrel and the machine frame inclination values αHactual, transverse inclination target values αHtarget are determined for successive waypoints sn, which target values are compared with the machine frame inclination values αHactual in order to set the lifting position of the lifting column 7A of the rear right-hand running gear unit 7 in such a way that the difference between the transverse inclination target values αHtarget and the machine frame inclination values αHactual is minimised.

The steps described above are carried out continuously for the individual waypoints 1, 2, 3, 4, 5 . . . sn, as can be seen from the table (FIG. 13). The absolute transverse inclination at a waypoint (sn+1) that is ahead in the working direction is thus calculated from the relative transverse inclination αrelative determined at this waypoint and the absolute transverse inclination αabs determined at the waypoint (sn) that is behind in the working direction. This is illustrated by the following example:

αabs(sn)=0.2%[waypoint behind] a.

αrelative(sn+1)=3.2 mm/1600 mm×100%=0.2%[waypoint ahead] b.

αabs(sn+1)=αabs(sn)+αrelative(sn+1)=0.2%+0.2%=0.4% b.

In this way, the transverse inclination αabs of the unmachined substrate surface 8 relative to the horizontal is continuously determined and is used as a transverse inclination target value αHtarget for control.

The transverse inclination target values αHtarget (reference variable W) are determined by summation of the transverse inclination αabs of the machine frame 3 or rotational axis 10A of the milling drum A relative to the horizontal H and the transverse inclination αrel of the machine frame relative to the unmachined substrate surface 8.

The block diagram of FIG. 15 illustrates the control system of the alternative embodiment. The frame inclination sensor 30 represents the measuring device of the control loop. The alternative embodiment therefore makes use of an additional frame inclination sensor 30 with an inclination sensor 30A. The controlled variable X is the transverse inclination αHactual measured using the frame inclination sensor 30. The aim of the control is to bring the controlled variable X to the reference variable W (αHtarget) with the aid of the manipulated variable Y, which is influenced by the adjustment device 27, wherein the control deviation E=W−X should be as small as possible. In the present control loop, the lifting column 7A of the rear right-hand running gear unit 7 represents the adjustment device 27 of the control loop. The control signal of the lifting column 7A of the rear right-hand running gear unit 7 represents the manipulated variable Y.

The closed-loop controller 26 is configured such that the time-variable controlled variable X is influenced by the retraction or extension of the lifting column 7A of the rear right-hand running gear unit 7 in such a way that the control deviation E=W−X is as small as possible. Disturbance variables Z acting on the controlled system 28 can still be taken into account in this control.

The block diagram shows the routine 31 for determining ΔFactual from the distance values FL and FR (ΔFactual=FL−FR). From ΔFactual, the routine 32 continuously determines the relative transverse inclination αrelative of the surface 8 of the non-milled substrate relative to the machine frame 3. From the relative transverse inclination αrelative, the absolute transverse inclination αabsolute of the surface 8 of the non-milled substrate relative to the horizontal is determined by summation and is subsequently used as a transverse inclination target value αHtarget for control.

Since the contact points 4′, 5′ of the front running gear units 4, 5 are located at a distance I from the contact points 6′, 7′ of the rear running gear units 6, 7, the continuously determined values for the absolute transverse inclination αHabs of the substrate surface 8 in relation to the horizontal H are temporarily stored as αHtarget (routine 33). These temporarily stored values are then read out again at the relevant waypoint as a target value (reference variable W) for the control. This target value is compared with the actual value of the transverse inclination αHactual of the machine frame 3 or of the milling drum axis 10A relative to the horizontal H, which is measured using the frame inclination sensor 30 (E=W−X).

It is noted that the various sensors described herein are described as determining various values (plural) of a given parameter during the milling operation. For example, the distance sensor 19 may be described as being configured to determine distance values corresponding to a distance between the reference point R and the substrate surface. It will be understood that at any one waypoint or time during a milling process the sensor may only generate a single value and as the milling process proceeds the sensor will determine additional values at additional waypoints.

1. A self-propelled substrate milling machine, comprising:
a machine frame;
a milling drum arranged on the machine frame;
a front left-hand running gear unit, a front right-hand running gear unit, a rear left-hand running gear unit, and a rear right-hand running gear unit configured to support the milling machine from a substrate surface;
a plurality of lifting columns, each of the lifting columns supporting the machine frame from an associated one of the running gear units, each of the lifting columns being configured to be retracted or extended in order to raise or lower its associated running gear unit relative to the machine frame, the plurality of lifting columns including at least a rear left-hand lifting column and a rear right-hand lifting column;
the front running gear units being operably associated with each other such that a raising of the front left-hand running gear unit causes a lowering of the front right-hand running gear unit, and a lowering of the front left-hand running gear unit causes a raising of the front right-hand running gear unit;
a distance sensor configured to determine distance values corresponding to a distance between a reference point relating to the machine frame and the substrate surface;
a transverse inclination sensor system configured to determine transverse inclination values representative of a position of at least one of the front left-hand running gear unit and the front right-hand running gear unit relative to the machine frame, the transverse inclination values describing a transverse inclination of an un-milled substrate surface relative to the machine frame and transverse to a working direction of the milling machine; and
a controller configured to receive the distance values and the transverse inclination values and to generate control signals for the lifting column of at least one of the rear running gear units such that a rotational axis of the milling drum is oriented substantially parallel to the substrate surface to be milled.

2. The self-propelled substrate milling machine according to claim 1, wherein:
the plurality of lifting columns includes a front left-hand lifting column and a front right-hand lifting column force-coupled to one another such that the raising of the front left-hand running gear unit causes the lowering of the front right-hand running gear unit, and the lowering of the front left-hand running gear unit causes the raising of the front right-hand running gear unit.

3. The self-propelled substrate milling machine according to claim 1, wherein:
the front running gear units are connected to the machine frame in a manner of a full-floating mounting such that the raising of the front left-hand running gear unit causes the lowering of the front right-hand running gear unit, and the lowering of the front left-hand running gear unit causes the raising of the front right-hand running gear unit.

4. Self-propelled substrate milling machine according to claim 1, wherein the controller is configured such that:
the transverse inclination value determined by the transverse inclination sensor system is monitored and after a determination of a change in the transverse inclination between successive waypoints of a distance travelled by the milling machine at least one of the rear lifting columns is retracted or extended by an amount such that the rotational axis of the milling drum is again oriented substantially parallel to the substrate surface to be milled.

5. The self-propelled substrate milling machine according to claim 4, wherein the controller is configured such that:
after the determination that the change in the transverse inclination between successive waypoints has occurred, the at least one of the rear lifting columns is retracted or extended by the amount only after a prespecified distance has been travelled or after a prespecified time interval has elapsed, the prespecified time interval being a function of an advance speed of the milling machine.

6. The self-propelled substrate milling machine according to claim 1, wherein:
the controller includes a memory and the controller is configured to store the transverse inclination value in association with successive waypoints of a distance travelled by the milling machine or at successive points in time.

7. The self-propelled substrate milling machine according to claim 1, wherein:
the transverse inclination sensor system includes a left-hand distance sensor configured to determine left-hand distance values corresponding to the position of the front left-hand running gear unit relative to the machine frame and a right-hand distance sensor configured to determine right-hand distance values corresponding to the position of the front right-hand running gear unit relative to the machine frame; and
the controller is configured such that:
the rear right-hand lifting column is retracted when the left-hand distance value decreases and the right-hand distance value increases during an advance of the milling machine; and
the rear right-hand lifting column is extended when the left-hand distance value increases and the right-hand distance value decreases during the advance of the milling machine;
so that the rotational axis of the milling drum remains substantially parallel to the surface of the un-milled substrate during advance of the milling machine.

8. The self-propelled substrate milling machine according to claim 1, wherein:
the transverse inclination sensor system includes a left-hand distance sensor configured to determine left-hand distance values corresponding to the position of the front left-hand running gear unit relative to the machine frame and a right-hand distance sensor configured to determine right-hand distance values corresponding to the position of the front right-hand running gear unit relative to the machine frame; and
the controller is configured such that during an advance of the milling machine the lifting position of the rear right-hand lifting column is adjusted such that a difference between the left-hand distance value and the right-hand distance value is minimized.

9. The self-propelled substrate milling machine according to claim 1, wherein:
the transverse inclination sensor system includes a left-hand distance sensor configured to determine left-hand distance values corresponding to the position of the front left-hand running gear unit relative to the machine frame and a right-hand distance sensor configured to determine right-hand distance values corresponding to the position of the front right-hand running gear unit relative to the machine frame;
the milling machine further includes a frame inclination sensor configured to determine machine frame inclination values describing an inclination of the machine frame relative to horizontal; and
the controller is configured such that:
during an advance of the milling machine the transverse inclination values describing the transverse inclination of the un-milled substrate relative to the machine frame are determined from the left-hand and right-hand distance values;
transverse inclination target values are determined from the transverse inclination values and the machine frame inclination values for successive waypoints; and
the lifting position of the rear right-hand lifting column is adjusted such that a difference between the transverse inclination target value for a given waypoint and the machine frame inclination value at the given waypoint is minimized.

10. The self-propelled substrate milling machine according to claim 1, wherein:
the distance sensor is configured such that the reference point relating to the machine frame lies on a longitudinal side of the machine frame.

11. A method of controlling a self-propelled substrate milling machine, the milling machine including:
a machine frame;
a milling drum arranged on the machine frame;
a front left-hand running gear unit, a front right-hand running gear unit, a rear left-hand running gear unit, and a rear right-hand running gear unit configured to support the milling machine from a substrate surface; and
a plurality of lifting columns, each of the lifting columns supporting the machine frame from an associated one of the running gear units, each of the lifting columns being configured to be retracted or extended in order to raise or lower its associated running gear unit relative to the machine frame, the plurality of lifting columns including at least a rear left-hand lifting column and a rear right-hand lifting column;
the method comprising:
operably associating the front running gear units with each other such that a raising of the front left-hand running gear unit causes a lowering of the front right-hand running gear unit, and a lowering of the front left-hand running gear unit causes a raising of the front right-hand running gear unit;
determining distance values corresponding to a distance between a reference point relating to the machine frame and the substrate surface;
determining transverse inclination values representative of a position of at least one of the front left-hand running gear unit and the front right-hand running gear unit relative to the machine frame, the transverse inclination values describing a transverse inclination of an un-milled substrate surface relative to the machine frame and transverse to a working direction of the milling machine; and
controlling the lifting column of at least one of the rear running gear units as a function of the distance values and the transverse inclination values such that a rotational axis of the milling drum is oriented substantially parallel to the substrate surface to be milled.

12. The method according to claim 11, wherein:
the operably associating the front running gear units with each other is provided in that the plurality of lifting columns includes a front left-hand lifting column and a front right-hand lifting column force-coupled to one another such that the raising of the front left-hand running gear unit causes the lowering of the front right-hand running gear unit, and the lowering of the front left-hand running gear unit causes the raising of the front right-hand running gear unit.

13. The method according to claim 11, wherein:
the operably associating the front running gear units with each other is provided in that the front running gear units are connected to the machine frame in a manner of a full-floating mounting such that the raising of the front left-hand running gear unit causes the lowering of the front right-hand running gear unit, and the lowering of the front left-hand running gear unit causes the raising of the front right-hand running gear unit.

14. The method according to claim 11, wherein:
the transverse inclination values are monitored and after a determination of a change in the transverse inclination between successive waypoints of a distance travelled by the milling machine at least one of the rear lifting columns is retracted or extended by an amount such that the rotational axis of the milling drum is again oriented substantially parallel to the substrate surface to be milled.

15. The method according to claim 14, wherein:
after the determination that the change in the transverse inclination between successive waypoints has occurred, the at least one of the rear lifting columns is retracted or extended by the amount only after a prespecified distance has been travelled or after a prespecified time interval has elapsed, the prespecified time interval being a function of an advance speed of the milling machine.

16. The method according to claim 14, further comprising:
saving the transverse inclination values determined at successive points in time and/or at successive waypoints.

17. The method according to claim 11, wherein:
the reference point relating to the machine frame lies on a longitudinal side of the machine frame.

18. The method according to claim 11, wherein:
the determining of the transverse inclination values includes determining left-hand distance values corresponding to the position of the front left-hand running gear unit relative to the machine frame and right-hand distance values corresponding to the position of the front right-hand running gear unit relative to the machine frame; and
the method further includes:
retracting the rear right-hand lifting column when the left-hand distance value decreases and the right-hand distance value increases during an advance of the milling machine; and
extending the rear right-hand lifting column when the left-hand distance value increases and the right-hand distance value decreases during the advance of the milling machine;
thereby maintaining the rotational axis of the milling drum substantially parallel to the surface of the un-milled substrate during advance of the milling machine.

19. The method according to claim 11, wherein:
the determining of the transverse inclination values includes determining left-hand distance values corresponding to the position of the front left-hand running gear unit relative to the machine frame and right-hand distance values corresponding to the position of the front right-hand running gear unit relative to the machine frame; and
during an advance of the milling machine the lifting position of the rear right-hand lifting column is adjusted such that a difference between the left-hand distance value and the right-hand distance value is minimized.

20. The method according to claim 11, wherein:
the determining of the transverse inclination values includes determining left-hand distance values corresponding to the position of the front left-hand running gear unit relative to the machine frame and right-hand distance values corresponding to the position of the front right-hand running gear unit relative to the machine frame, and determining the transverse inclination values from the left-hand distance values and the right-hand distance values; and
the method further includes:
determining machine frame inclination values describing an inclination of the machine frame relative to horizontal;
determining transverse inclination target values from the transverse inclination values and the machine frame inclination values for successive waypoints; and
adjusting the lifting position of the rear right-hand lifting column such that a difference between the transverse inclination target value for a given waypoint and the machine frame inclination value at the given waypoint is minimized.
